(19) United States
(12) Patent Application Publication
(10) Pub. No.: US 2026/0203163 A1
(43) Pub. Date: Jul. 16, 2026

(54) IN-PACKAGE ERROR CORRECTION FOR MULTI-DIE MEMORY STACKS

(71) Applicant: Rambus Inc., San Jose, CA (US)

(72) Inventors: Wendy ELSASSER, Austin, TX (US); Dongyun LEE, Sunnyvale, CA (US); John Eric LINSTADT, Palo Alto, CA (US)

(21) Appl. No.: 19/135,771

(22) PCT Filed: Dec. 4, 2023
(86) PCT No.: PCT/US2023/082384

§ 371 Date: Jun. 4, 2025

Related U.S. Application Data
(60) Provisional application No. 63/430,934, filed on Dec. 7, 2022.

(51) Int. Cl. G06F 11/10

(52) U.S. Cl. CPC G06F 11/1044

(57) ABSTRACT

A memory device comprises a plurality of memory die arranged in a vertical stack. Each of the plurality of memory die comprises a memory array and an error correction circuit. The error correction circuit of at least one of the plurality of memory die is configured to generate parity information for data to be stored in the memory device, and at least a portion of the parity information is stored in the memory array of at least one other memory die of the plurality of the memory die.

### BACKGROUND

Many computer systems use certain types of memory devices, such as dynamic random access memory (DRAM) devices, as system memory to temporarily store an operating system, critical applications, and data. With widespread use of multi-core processors, particularly, in servers and workstations, higher capacity and faster memory devices are needed to catch up with the computing power of these processors, thereby reducing the processor-memory performance gap and allowing the applications to use the full processing speed of modern processors. One way in which the processor-memory performance gap can be addressed is to increase storage capacity by stacking memory die, while using existing memory technologies. For example, in servers and storage applications, stacking can be used to obtain high memory densities in a smaller space and at a lower cost. Other industrial or embedded applications may have different memory requirements, but typically high-density stacking can be used where space is constrained, such as in mobile computing devices. Such memory includes multiple memory dies stacked together in a single package with multiple channels available to access the memory dies in order to provide comparable performance to other types of memory modules (e.g., a dual in-line memory module (DIMM)), but while consuming less power. As these memory types are beginning to be used in different markets, such as high-performance computing (HPC), servers, automotive, etc., there are stronger reliability, availability, and serviceability (RAS) expectations, such as single die data correction (SDDC), for example. As the individual memory dies already implement on-die error correction code (ECC) to mitigate single bit errors on the individual die, such individual functionality can be combined across multiple memory dies in the stack to provide in-package error correction capability.

### BRIEF DESCRIPTION OF THE DRAWINGS

The present disclosure is illustrated by way of example, and not by way of limitation, in the figures of the accompanying drawings.

FIG. 1 is a block diagram illustrating a computing system with a memory device including multiple stacked memory dies, according to an embodiment.

FIG. 2 is a block diagram illustrating a memory die stack configured for in-package error correction, according to an embodiment.

FIG. 3 is a block diagram illustrating a memory die stack configured for in-package error correction, according to an embodiment.

FIG. 4 is a block diagram illustrating a memory die stack configured for in-package error correction, according to an embodiment.

FIG. 5 is a block diagram illustrating shared command and address signals in a memory die stack, according to an embodiment.

### DETAILED DESCRIPTION

The following description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

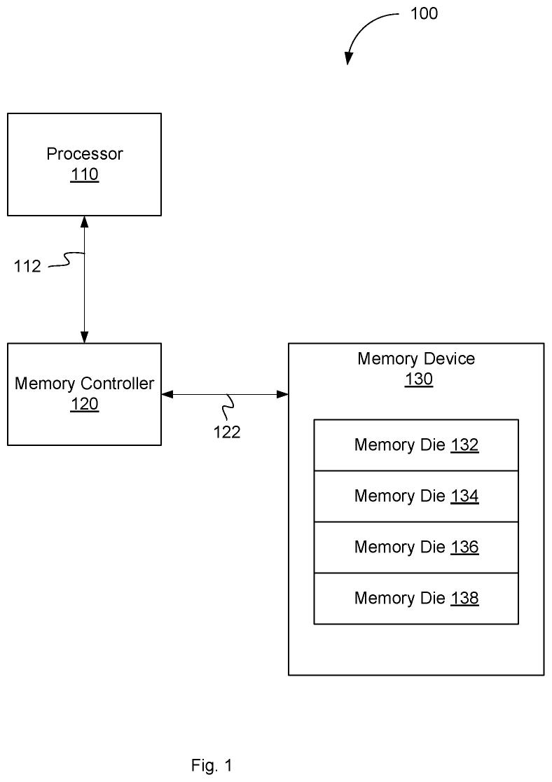

Aspects of the present disclosure include in-package error correction for multi-die memory stacks. In one embodiment, a multi-die memory package including a plurality of stacked memory dies, such as LPDRAM dies, is designed to apply ECC operations across data from multiple dies without any stored data overhead increase (i.e., without adding additional memory dies for storing the parity data used in the ECC operations). If for example, 8 bits of parity information are generated and used to perform single error correction on 128 bits of data, both the data and the parity information can be distributed across multiple memory dies in the stack for storage. For example, an ECC engine on one die in the stack can perform ECC operations to generate the parity information for the data and store at least a portion of that data and the parity information in a memory array on the same die. In certain embodiments, the ECC engine can further send a remaining portion of the data and the parity information to another die in the stack for storage. In addition, the ECC engine can correct data read from the memory array on the same die, as well as data read from one or more other memory dies in the stack, using the parity information from both the same die and from the one or more other memory dies. In an embodiment, in-package error correction is provided, for example, to satisfy the RAS requirements of LPDRAM memory, while improving performance and providing power savings, such as by eliminating the over-fetching associated with on-die error correction across multiple stacked memory dies. Additional details with respect to the in-package error correction for multi-die memory stacks are provided below with respect to FIGS. 1-5.

FIG. 1 is a block diagram illustrating a computing system 100 with a memory device 130 including multiple stacked memory dies, according to an embodiment. As illustrated, the memory device 130 includes a stack of memory dies 132, 134, 136, 138, arranged together in a single package. Each of memory dies 132, 134, 136, 138 can include an array of memory cells, such as DRAM or some other memory type, as well as associated circuitry and control logic including, for example, an ECC engine. Depending on the embodiment, memory device 130 can have some other number of memory dies and/or some other type of memory.

Each of memory dies 132, 134, 136, 138 may include a memory core (e.g., memory array), a number of low-resistance metal layers, and an interface for communication with the memory controller 120. In one embodiment, the memory die stack is coupled to a packaging substrate that holds integrated circuit (IC) terminals via which the memory dies communicate with other devices, such as memory controller 120. In one embodiment, the memory dies 132, 134, 136, 138 in the stack are physically separated from one another by non-conducting layers (e.g., a Silicon substrate). In one embodiment, the memory dies 132, 134, 136, 138 in the stack are interconnected via a number of respective interconnections, such as through-silicon vias (TSVs), as will be described in more detail below.

In one embodiment, memory device 130 communicates with a memory controller 120 via a memory bus 122. In one embodiment, the memory controller 120 includes logic circuitry that controls memory access operations, such as read, write, and refresh operations, performed on memory device 130. The read and write operations may be performed in response to requests received from a processor 110, or other host system, over bus 112. In one embodiment, computing system 100 includes one or more additional memory devices 130 also coupled to memory controller 120, via memory bus 122 or a different memory bus. In one embodiment, the memory bus 122 includes a data bus and a command/address bus, each comprising a number of data and command/address lines, respectively. The command portion of the command/address bus conveys instructions such as read, write, and refresh commands issued by the memory controller 120. The address portion of the command/address bus may comprise a number of address lines carrying signals that identify the location of data in the memory device 130.

In one embodiment, an ECC engine on one of memory dies 132, 134, 136, 138 in the stack of memory dies in memory device 130 (e.g., memory die 132) can perform ECC operations to generate the parity information for data to be stored at memory device 130 (e.g., an 8 bit parity symbol for a 128 bit data word) and store at least a portion of that data and the parity information in a memory array on the same die (e.g., memory die 132). For example, digital logic on the memory die can generate and check an ECC code word. An example implementation could include Single Error Correction (SEC) capability with a 136-bit Hamming code word with 8 parity bits covering 128-bits of data. In certain embodiments, the ECC engine can further send a remaining portion of the data and the parity information to another die in the stack for storage (e.g., memory die 134). In another embodiment, the ECC engines on multiple ones of memory dies 132, 134, 136, 138 can each generate the parity information for a portion of the data to be stored at memory device. In addition, the ECC engine on memory die 132 can correct data read from the memory array on the same memory die 132, as well as data read from memory die 134, using the parity information from both memory die 132 and memory die 134. Such in-package error correction can be implemented in a number of different ways, as described in more detail below.

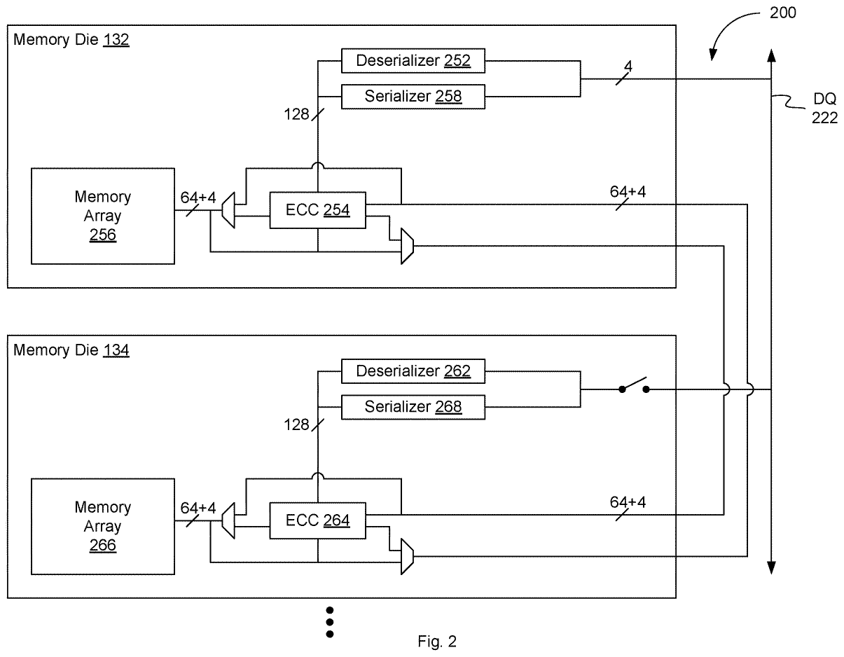

FIG. 2 is a block diagram illustrating a memory die stack 200 configured for in-package error correction, according to an embodiment. In one embodiment, the stack 200 includes two or more memory die, such as memory die 132 and memory die 134. Although not illustrated in FIG. 2, it should be understood that memory die stack 200 can include additional memory die, such as illustrated in FIG. 1, for example. Memory die 132 includes a connection to a data bus 222 (e.g., DQ bus) which can be one part of memory bus 122. In one embodiment, memory die 132 receives a serialized data stream (e.g., 32 beats at 4 bits each) from the data bus 222 including data to be written to the memory device including memory die stack 200. As illustrated, memory die 134 and any other memory dies in memory die stack 200 can be disconnected from the data bus 222. In one embodiment, the serialized data stream is received at deserializer 252 of memory die 132, which can convert the serialized data stream into deserialized data (e.g., a 128 bit data word). This deserialized data can be input to ECC engine 254 of memory die 132. Although only two dies are illustrated in FIG. 2, it should be understood that memory die stack 200 can include any number of memory dies, each having the same or similar hardware components (e.g., ECC engine, serializer, deserializer), such that any of the memory dies in the memory die stack. 200 can be the memory die that is connected to data bus 222, receives the data to be programmed, and performs the ECC operations. In one embodiment, during a die test (e.g., before memory die stack 200 is assembled), the hardware of each die can be used to test each respective memory array.

ECC engine 254 can perform ECC operations on the 128 bit data word to generate parity information (e.g., an 8 bit parity symbol) which can be used to detect and/or correct errors in the data when later accessed. In one embodiment, the ECC engine 254 stores a portion of the data (e.g., half the data or 64 bits) and a portion of the parity information (e.g., half of the parity symbol or 4 bits) in memory array 256 on memory die 132. In addition, ECC engine 254 can transfer a remaining portion of the data (e.g., the other half of the data or 64 bits) and a remaining portion of the parity information (e.g., the other half of the parity symbol or 4 bits) to another memory die in the memory die stack 200, such as memory die 134. Those remaining portions of the data and the parity information can be stored in memory array 266 on memory die 134. Depending on the embodiment, memory array 256 and memory array 266 can be an array of memory cells including DRAM, or some other memory type.

In one embodiment, memory die 134 includes deserializer 262, ECC engine 264, and serializer 268, but such components are disabled, deactivated, bypassed (e.g., through a switching network), or not simply not used. In another embodiment, memory die 134 does not include deserializer 262, ECC engine 264, or serializer 268 at all. In this manner, the ECC engine on a single memory die in the memory die stack, such as ECC engine 254 of memory die 132, performs the ECC operations on data for multiple memory dies, such that portions of the data and the parity information can be stored across the multiple memory dies. In other embodiments, portions of the data and the parity information can be stored across additional memory dies (e.g., 3 or more memory dies) and the sizes and amounts of the portions of the data and the parity information stored at each memory die can vary accordingly.

When a request to read data stored in memory die stack 200 is received, ECC engine 254 on memory die 132 receives the portion of the data and the portion of the parity information from memory array 256 and receives the portion of the data and the portion of the parity information from memory array 266 on memory die 134. Since ECC engine 254 now has all of the data and all of the parity information, it can determine whether there are any errors in the data and correct any identified errors using the parity information. For example, ECC engine 254 can recalculate the parity information based on the data read from memory array 256 and memory array 266, and compare that recalculated parity information to the previously calculated parity information read from memory array 256 and memory array 266. If the recalculated parity information and the previously calculated parity information do not match, ECC engine 254 can determine that there are one or more errors in the data and can correct those errors (e.g., by flipping one or more bits). ECC engine 254 can provide the corrected data (i.e., 128 bits) to serializer 258 on memory die 132, which can convert the deserialized data stream back into a serialized data stream (e.g., 32 beats at 4 bits each) which can be transmitted back to the memory controller or host system via data bus 222. In addition, ECC engine 254 can perform an error scrubbing operation on the data. During error scrubbing, data and parity information from both memory array 256 and memory array 266 are processed by ECC engine 254, any single bit error is corrected, and both the data and parity information are written back to memory array 256 and memory array 266.

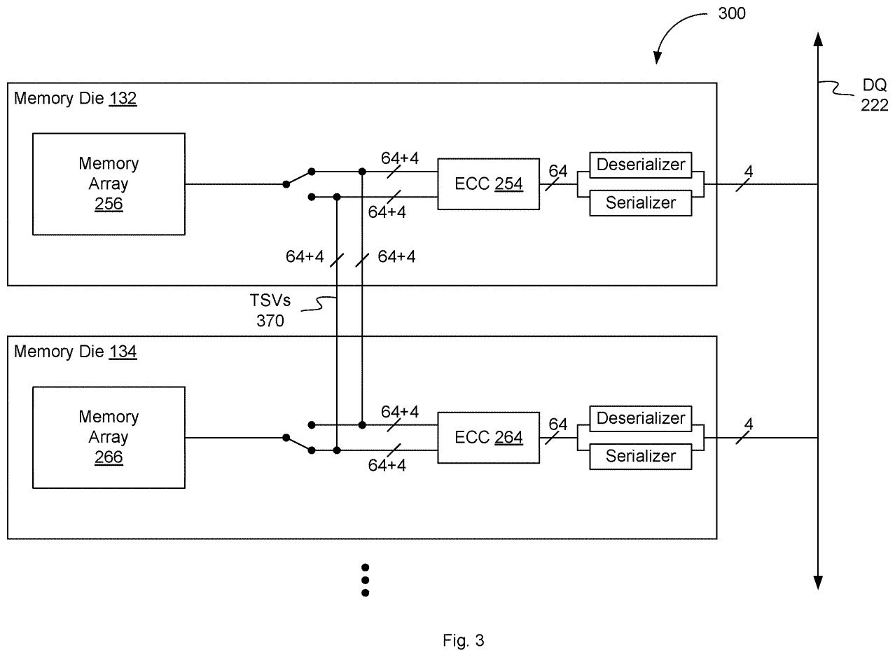

FIG. 3 is a block diagram illustrating a memory die stack 300 configured for in-package error correction, according to an embodiment. In one embodiment, the stack 300 includes two or more memory die, such as memory die 132 and memory die 134. Although not illustrated in FIG. 3, it should be understood that memory die stack 300 can include additional memory die, such as illustrated in FIG. 1, for example. Memory die 132 and memory die 134 form a logical pair of memory dies for purposes of in-package error correction, and other memory dies in the memory die stack 300 can be similarly grouped into logical pairs. Memory die 132 and memory die 134 each include a connection to a data bus 222 (e.g., DQ bus) which can be one part of memory bus 122. In one embodiment, each of memory die 132 and memory die 134 receive, from data bus 222, a serialized data stream (e.g., 16 beats at 4 bits each) from the data bus 222 including data to be written to the memory device including memory die stack 300. In one embodiment, the serialized data stream is received at a deserializer of each memory die (as described above with respect to FIG. 2), which can convert the serialized data stream into deserialized data (e.g., 64 bit data). This deserialized data can be input to the respective ECC engines of each memory die. In one embodiment, each of memory die 132 and memory die 134 can share the respective portions of the data via a separate internal communication path (e.g., via TSVs 370), so that ECC engine 254 and ECC engine 264 each have the full 128 bits of data.

ECC engine 254 of memory die 132 can perform ECC operations on the 128 bit data to generate parity information (e.g., 8 bits of parity data) which can be used to detect and correct errors in the data. Similarly, ECC engine 264 of memory die 134 can perform ECC operations on the 128 bit data to generate parity information (e.g., 8 bits of parity data) which can be used to correct errors in the data. Once the parity information is calculated, ECC engine 254 can store a portion of the data (e.g., half the data or 64 bits) and a portion of the parity information (e.g., half of the parity data or 4 bits) in memory array 256 on memory die 132. In addition, ECC engine 264 can store another portion of the data (e.g., half the data or 64 bits) and another portion of the parity information (e.g., half of the parity data or 4 bits) in memory array 266 on memory die 134. For example, if ECC engine 254 stores the first half of the data and the first half of the parity information in memory array 256 on memory die 132, ECC engine 264 can store the second half of the data and the second half of the parity information in memory array 266 on memory die 134. In one embodiment, the portion of the data and parity information that is routed to the respective memory array on each memory die can be controlled by respective switching networks on each memory die.

When a request to read data stored in memory die stack 300 is received, ECC engine 254 on memory die 132 receives the portion of the data and the portion of the parity information from memory array 256 and ECC engine 264 on memory die 134 receives the portion of the data and the portion of the parity information from memory array 266. Each of ECC engine 254 and ECC engine 256 can calculate parity data (e.g., 8 bits) based on the portion of the data read from each respective memory array. For example, ECC engine 254 can calculate a first parity result based on the first portion of the data read from memory array 256 and on the second portion of the data read from memory array 266 and received via TSVs 370. Similarly, ECC engine 264 can calculate a second parity result based on the second portion of the data read from memory array 266 and on the first portion of the data read from the memory array 256 and received via TSVs 370. In one embodiment, the portions of the data and parity are transferred by through-silicon vias (TSVs) 370 which extend between memory die 132 and memory die 134 through a silicon substrate or other layer of non-conducting material (not shown) that separates memory die 132 and memory die 134. Each of ECC engine 254 and ECC engine 264 can then compare the calculated parity result with the full parity word to determine whether there are any errors in the data and can correct those errors (e.g., by flipping one or more bits). In one embodiment, a syndrome provides the location (and, for symbol based ECC, the magnitude) of errors in the data. The syndrome can be produced by evaluating the difference (XOR) between the received parity bits/symbols, and the expected parity, as calculated from the received data. Error correction (in either portion of the data) uses both portions of the data and both portions of the stored parity to calculate the syndrome. ECC engine 254 and ECC engine 264 can provide the respective portions of the corrected data (i.e., 64 bits) back to the memory controller or host system via data bus 222. In addition, ECC engine 254 and ECC engine 264 can perform error scrubbing operations on the data. During error scrubbing, data and parity information from both memory array 256 and memory array 266 are processed by ECC engine 254 and ECC engine 264, any single bit error is corrected, and both the data and parity information are written back to memory array 256 and memory array 266.

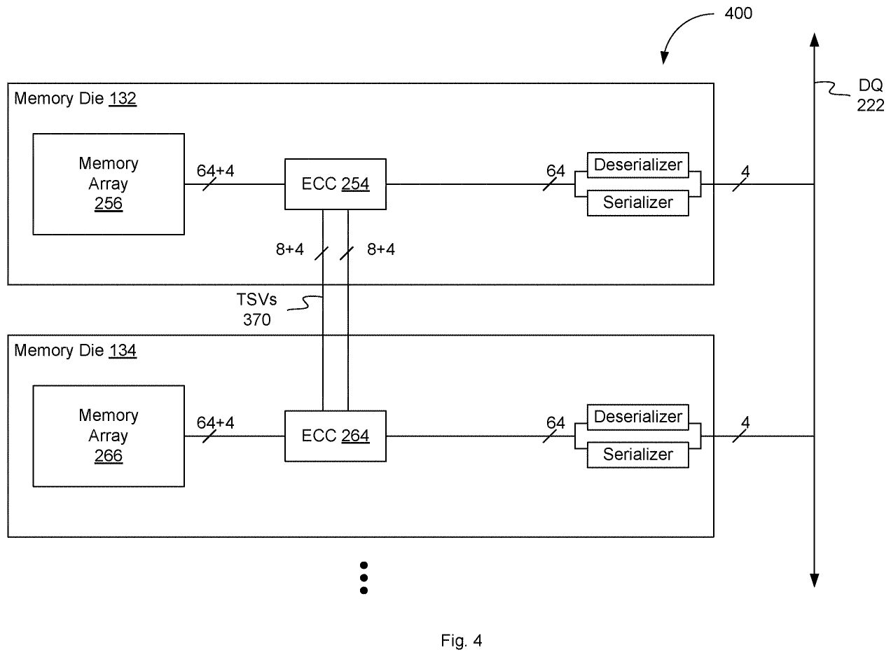

FIG. 4 is a block diagram illustrating a memory die stack 400 configured for in-package error correction, according to an embodiment. In one embodiment, the stack 400 includes two or more memory die, such as memory die 132 and memory die 134. Although not illustrated in FIG. 4, it should be understood that memory die stack 400 can include additional memory die, such as illustrated in FIG. 1, for example. Memory die 132 and memory die 134 form a logical pair of memory dies for purposes of in-package error correction, and other memory dies in the memory die stack 400 can be similarly grouped into logical pairs. Memory die 132 and memory die 134 each include a connection to a data bus 222 (e.g., DQ bus) which can be one part of memory bus 122. In one embodiment, each of memory die 132 and memory die 134 receive, from data bus 222, a portion of serialized data stream (e.g., 32 beats at 2 bits each) from the data bus 222 including data to be written to the memory device including memory die stack 400. In one embodiment, the serialized data stream is received at a deserializer of each memory die (as described above with respect to FIG. 2), which can convert the serialized data stream into deserialized data (e.g., 64 bit data). This deserialized data can be input to the respective ECC engines of each memory die.

ECC engine 254 of memory die 132 can perform ECC operations on the 64 bit data to generate a first intermediate result (e.g., an 8 bit parity) which can be used to correct errors in the data. Since ECC engine 254 receives only half of the data (e.g., a first half), in one embodiment, ECC engine 254 assumes that all bits in the other half of the data (e.g., a second half) are set to zero when calculating the first parity information. Similarly, ECC engine 264 of memory die 134 can perform ECC operations on the 64 bit data it receives to generate a second intermediate result (e.g., an 8 bit parity) which can be used to correct errors in the data. Since ECC engine 264 receives only the other half of the data, in one embodiment, ECC engine 264 assumes that all bits in the first half of the data are set to zero when calculating the second parity information.

Once the first and second parity information is calculated, ECC engine 254 and ECC engine 264 can exchange the first and second partial or intermediate parity information (e.g., intermediate results) with each other. In one embodiment, the first and second intermediate results are transferred by through-silicon vias (TSVs) 370 which extend between memory die 132 and memory die 134 through a silicon substrate or other layer of non-conducting material (not shown) that separates memory die 132 and memory die 134. In other embodiments, the first and second intermediate results are transferred between memory die 132 and memory die 134 by some other means, such as wire-bonding techniques. Upon receiving the intermediate results from the other die in the logical pair, each of ECC engine 254 and ECC engine 264 can logically combine (e.g., by performing an XOR operation) the received intermediate results with the intermediate results it generated itself to form a combined parity information. This combined parity information can thus be associated with the entire 128 bit data. ECC engine 254 and ECC engine 264 can store the portion of the data each has received (e.g., 64 bits) and a portion of the combined parity information (e.g., 4 bits) in the respective memory arrays 256 and 266 on each of memory die 132 and memory die 134. As a result, half of the data and half of the combined parity information is stored on each of memory die 132 and memory die 134.

When a request to read data stored in memory die stack 400 is received, ECC engine 254 on memory die 132 receives the portion of the data and the portion of the combined parity information from memory array 256 and ECC engine 264 on memory die 134 receives the portion of the data and the portion of the combined parity information from memory array 266. Each of ECC engine 254 and ECC engine 256 can calculate a sub-result (e.g., 8 bits) based on the portion of the data read from each respective memory array. For example, ECC engine 254 can calculate a first sub-result based on the first portion of the data read from memory array 256 and ECC engine 264 can calculate a second sub-result based on the second portion of the data read from memory array 266. ECC engine 254 and ECC engine 264 can exchange the first and second sub-results (e.g., through TSVs 370) along with the portion of the combined parity information (e.g., 4 bits) read from each respective memory array. Each of ECC engine 254 and ECC engine 264 can combine the received sub-result with the calculated sub-result and the combined parity information (e.g., via XOR). Each of ECC engine 254 and ECC engine 264 can then determine whether there are any errors in the data or parity (e.g., a codeword) and can correct those errors (e.g., by flipping one or more bits). In one embodiment, instead of sharing the received data between memory dies, the expected parity calculated from each respective portion of the data is shared with the other memory die to construct the complete expected parity. This, with the received parity bits from both portions, can be used to calculate a syndrome. ECC engine 254 and ECC engine 264 can provide the respective portions of the corrected data (i.e., 64 bits) back to the memory controller or host system via data bus 222. In addition, ECC engine 254 and ECC engine 264 can perform error scrubbing operations on the data. During error scrubbing, data and parity information from both memory array 256 and memory array 266 are processed by ECC engine 254 and ECC engine 264, any single bit error is corrected, and both the data and parity information are written back to memory array 256 and memory array 266.

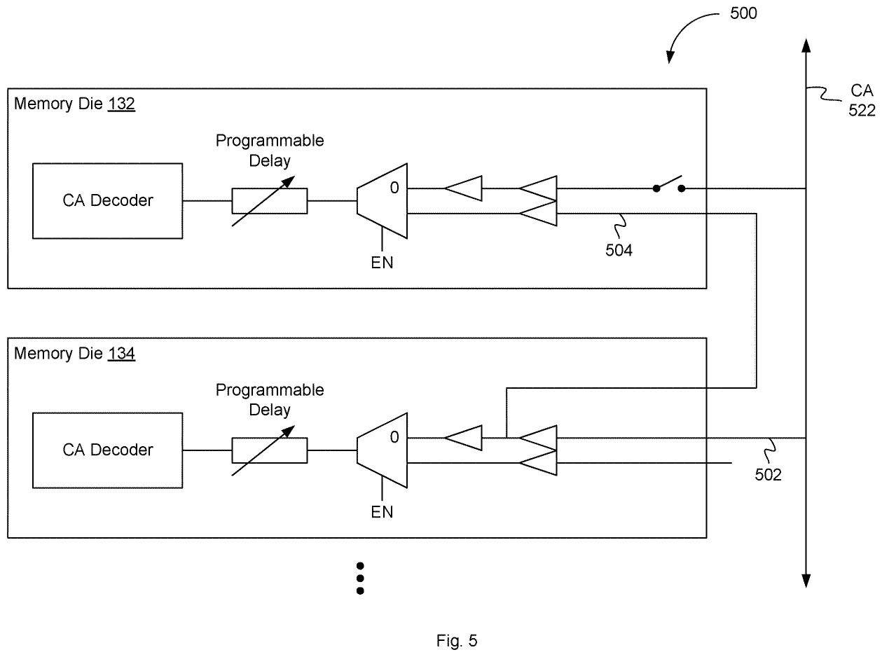

FIG. 5 is a block diagram illustrating shared command and address signals in a memory die stack 500, according to an embodiment. In one embodiment, the stack 500 includes two or more memory die, such as memory die 132 and memory die 134. Although not illustrated in FIG. 5, it should be understood that memory die stack 500 can include additional memory die, such as illustrated in FIG. 1, for example. Memory die 134 includes a connection to command and address bus 522 (e.g., CA bus) which can be one part of memory bus 122. In one embodiment, memory die 134 receives a CA signal from command and address bus 522, including for example, an indication of a memory command to be performed on the memory device including memory die stack 500 and/or a memory address indicating a location of data on which a memory operation is to be performed. As illustrated, memory die 132 and any other memory dies in memory die stack 500 can be disconnected from the command and address bus 522. In other embodiments, in addition to or instead of being connected to command and address bus 522, memory die 134 can receive a clock signal used in part of its operations.

Certain memory devices, such as LPDRAM devices, having a single die on which data is stored can utilize very low-power, low-voltage signals having relatively low loading. With multi-die memory stack, such as memory die stack 500, however, there is a need to distribute CA signals, clock (CK) signals, and/or write clock (WCK) signals to multiple memory dies instead of just the single die. As the loading in such an implementation has increased substantially compared to a single die system, there can be negative impacts on signal integrity and power utilization. Accordingly, in one embodiment with a multi-die memory stack 500, a single die, such as memory die 134 for example, can serve as a master die that captures signals from command and address bus 522 (or other clock signals) and redrives them within the memory die stack 500. For example, memory die 134 can receive CA signal 502 and redrive that signal to memory die 132 via signal 504. Each of memory die 132 and memory die 134 can include selection circuitry to select which signal to receive and can optionally include programmable delay circuitry used to align the received CA bus signals between memory dies internally before they are provided to respective CA decoder signals in each memory die. A similar approach can be used to redrive clock signals between the memory dies in memory die stack 500, as well.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those skilled in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “setting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any procedure for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

What is claimed is:

1. A memory device comprising:
a first memory die comprising:
a first interface circuit;
a first memory array; and
a first error correction circuit coupled to the first interface circuit and to first memory array; and
a second memory die vertically stacked with the first memory die, the second memory die comprising:
a second interface circuit;
a second memory array; and
a second error correction circuit coupled to the second interface circuit and to the second memory array, wherein the second error correction circuit is configured to generate parity information for data to be stored in the memory device, and wherein at least a portion of the parity information is stored in the first memory array of the first memory die and in the second memory array of the second memory die.

2. The memory device of claim 1, wherein the second interface circuit of the second memory die is configured to receive an entire data word to be stored at the memory device.

3. The memory device of claim 2, wherein the second error correction circuit of the second memory die is configured to:
generate the parity information for the entire data word;
store a first portion of the data word and a first portion of the parity information in the second memory array of the second memory die; and
provide a second portion of the data word and a second portion of the parity information to the first memory die to be stored in the first memory array of the first memory die.

4. The memory device of claim 3, wherein the second error correction circuit of the second memory die is configured to:
receive the first portion of the data word and the first portion of the parity information from the second memory array of the second memory die;
receive the second portion of the data word and the second portion of the parity information from the first memory die; and
correct one or more errors in the first portion of the data and the second portion of the data using the first portion of the parity information and the second portion of the parity information.

5. The memory device of claim 1, wherein the first interface circuit of the first memory die is configured to receive at least a portion of an entire data word to be stored at the memory device, and wherein the second interface circuit of the second memory die is also configured to receive at least a portion of the entire data word.

6. The memory device of claim 5, wherein the second error correction circuit of the second memory die is configured to:
generate the parity information for the entire data word; and
store a first portion of the data word and a first portion of the parity information in the second memory array of the second memory die.

7. The memory device of claim 6, wherein the second error correction circuit of the second memory die is configured to:
receive the first portion of the data word and the first portion of the parity information from the second memory array of the second memory die;
receive a second portion of the data word and a second portion of the parity information from the first memory die; and
correct one or more errors in the first portion of the data using the first portion of the parity information and the second portion of the parity information.

8. The memory device of claim 1, wherein the first interface circuit of the first memory die is configured to receive a first portion of a data word to be stored at the memory device, and wherein the second interface circuit of the second memory die is configured to receive a second portion of the data word.

9. The memory device of claim 8, wherein the second error correction circuit of the second memory die is configured to:
generate a first portion of the parity information for the second portion of the data word;
receive a second portion of the parity information for the first portion of the data word from the first memory die;
generate combined parity information based on the first portion and the second portion of the parity information; and
store the second portion of the data word and a first portion of the combined parity information in the second memory array of the second memory die.

10. The memory device of claim 9, wherein the second error correction circuit of the second memory die is configured to:
receive the second portion of the data word and the first portion of the combined parity information from the second memory array of the second memory die;
calculate a first sub-result based on the second portion of the data word;
receive the second portion of the combined parity information and a second sub-result from the first memory die, wherein the second sub-result is calculated based on the first portion of the data word; and
correct one or more errors in the second portion of the data using the first portion and the second portion of the combined parity information and using the first sub-result and the second sub-result.

11. A memory device comprising:
a plurality of memory die arranged in a vertical stack, wherein each of the plurality of memory die comprises a memory array and an error correction circuit, wherein the error correction circuit of at least one of the plurality of memory die is configured to generate parity information for data to be stored in the memory device, and wherein at least a portion of the parity information is stored in the memory array of at least one other memory die of the plurality of the memory die.

12. The memory device of claim 11, wherein one memory die of the plurality of memory die is configured to receive an entire data word to be stored at the memory device.

13. The memory device of claim 12, wherein the error correction circuit of the one memory die is configured to:
generate the parity information for the entire data word;
store a first portion of the data word and a first portion of the parity information in the memory array of the one memory die; and
provide a second portion of the data word and a second portion of the parity information to the at least one other memory die of the plurality of the memory die to be stored in the memory array of the at least one other memory die.

14. The memory device of claim 13, wherein the error correction circuit of the one memory die is configured to:
receive the first portion of the data word and the first portion of the parity information from the memory array of the one memory die;
receive the second portion of the data word and the second portion of the parity information from the at least one other memory die; and
correct one or more errors in the first portion of the data and the second portion of the data using the first portion of the parity information and the second portion of the parity information.

15. The memory device of claim 11, wherein a first memory die of the plurality of memory die is configured to receive at least a portion of an entire data word to be stored at the memory device, and wherein a second memory die of the plurality of memory die is also configured to receive at least a portion of the entire data word.

16. The memory device of claim 15, wherein the error correction circuit of the second memory die is configured to:
generate the parity information for the entire data word; and
store a first portion of the data word and a first portion of the parity information in the memory array of the second memory die.

17. The memory device of claim 16, wherein the error correction circuit of the second memory die is configured to:
receive the first portion of the data word and the first portion of the parity information from the memory array of the second memory die;
receive a second portion of the data word and a second portion of the parity information from the first memory die; and
correct one or more errors in the first portion of the data using the first portion of the parity information and the second portion of the parity information.

18. The memory device of claim 11, wherein a first memory die of the plurality of memory die is configured to receive a first portion of a data word to be stored at the memory device, and wherein a second memory die of the plurality of memory die is configured to receive a second portion of the data word, and wherein the error correction circuit of the second memory die is configured to:
generate a first portion of the parity information for the second portion of the data word;
receive a second portion of the parity information for the first portion of the data word from the first memory die;
generate combined parity information based on the first portion and the second portion of the parity information; and
store the second portion of the data word and a first portion of the combined parity information in the memory array of the second memory die.

19. The memory device of claim 18, wherein the error correction circuit of the second memory die is configured to:
receive the second portion of the data word and the first portion of the combined parity information from the memory array of the second memory die;
calculate a first sub-result based on the second portion of the data word;
receive the second portion of the combined parity information and a second sub-result from the first memory die, wherein the second sub-result is calculated based on the first portion of the data word; and
correct one or more errors in the second portion of the data using the first portion and the second portion of the combined parity information and using the first sub-result and the second sub-result.

20. A method comprising:
receiving, at a first memory die of a memory device, data to be stored at the memory device, the memory device comprising a plurality of memory die arranged in a vertical stack, wherein each of the plurality of memory die comprises a memory array and an error correction circuit; and
generating, by the error correction circuit of the first memory die, parity information for the data to be stored in the memory device, wherein at least a portion of the parity information is stored in the memory array of at least one other memory die of the plurality of the memory die.
